(19) United States
(12) Patent Application Publication
(10) Pub. No.: US 2016/0201468 A1
(43) Pub. Date: Jul. 14, 2016

(54) TURBINE AIRFOIL

(71) Applicant: General Electric Company, Schenectady, NY (US)

(72) Inventors: Prabakaran Modachur Krishnan, Bangalore (IN); Joseph Anthony Cotroneo, Clifton Park, NY (US)

(73) Assignee: General Electric Company

(21) Appl. No.: 14/595,321

(22) Filed: Jan. 13, 2015

(51) Int. Cl. F01D 5/14; F01D 9/04

(52) U.S. Cl. CPC F01D 5/141; F01D 9/041; F05D 2220/31; F05D 2240/12; F05D 2240/30; F05D 2250/712; F05D 2250/711

(57) ABSTRACT

The present invention is an aerodynamically efficient turbine airfoil that includes a first endwall, a second endwall, a stacking axis, an aspect ratio, a percentage radial span, a tangential offset, and an angle; wherein relationships between the aspect ratio, percentage radial span, and angle are defined.

### BACKGROUND OF THE INVENTION

The present invention relates generally to turbomachines, and more particularly to an aerodynamically efficient turbine airfoil that includes a first endwall, a second endwall, a stacking axis, an aspect ratio, a percentage radial span, a tangential offset, and an angle; wherein relationships between the aspect ratio, percentage radial span, and angle are defined.

In a steam turbine, a working fluid such as dry pressurized steam is passed through one or more expansion sections that convert the thermal and kinetic energy from the steam to mechanical torque acting on a rotating shaft or other element, thereby producing power used for driving an external load, such as an electric generator. As used herein, the term “steam turbine” may encompass stationary or mobile turbomachines, and may have any suitable arrangement that causes rotation of one or more shafts.

In an axial-flow reheat steam turbine, the steam first passes through a high pressure section where energy is extracted through expansion and cooling of the steam. The steam is then directed to a reheater that raises the temperature of the steam. The reheated steam is then passed through an intermediate pressure section where additional energy is extracted through further expansion and cooling. The steam is then directed to a low pressure section where most of the remaining energy is extracted prior to condensing the steam to water.

The high, intermediate and low pressure expansion sections contain a plurality of stationary and rotating airfoils that extract work from the steam. The aerodynamic surfaces of the airfoils are oriented in a direction generally perpendicular to the axis of rotation, and are held in place by annular endwalls, platforms, shrouds, or any other means (hereinafter collectively referred to as “endwalls”) providing structural support for the airfoil and having surfaces oriented in a direction generally parallel to the axis of rotation.

The regions where the aerodynamic surfaces of the airfoils join to the endwalls are typically characterized by flow turbulence and misdirection, which are caused by boundary layer flow and cross passage pressure gradients. This flow characteristic may cause a substantial loss of aerodynamic efficiency, also known as secondary loss. The degree of secondary loss is also related to the relationship between the length and width of the airfoil, also known as aspect ratio.

It is therefore desirable to modify the geometry of the airfoils in the regions where the aerodynamic surfaces join to the endwalls in order to minimize the secondary loss and to compensate for the effect of airfoil aspect ratio.

### BRIEF DESCRIPTION OF THE INVENTION

Embodiments of the present invention are summarized below. These embodiments are not intended to limit the scope of the claimed invention, but rather, these embodiments are intended only to provide a brief summary of possible forms of the invention. Furthermore, the invention may encompass a variety of forms that may be similar to or different from the embodiments set forth below, commensurate with the scope of the claims.

According to a first embodiment of the present invention, a turbine airfoil includes a concave surface, a convex surface, a leading edge, a trailing edge, a first endwall, and a second endwall; wherein an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further having a plurality of radially stacked cross sections disposed about and at right angles to a stacking axis disposed substantially in the radial direction between the first endwall and the second endwall; each cross section including a portion of the concave surface, convex surface, leading edge, and trailing edge; and further having a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and where AR is equal to or greater than about 3, Z″ is greater than about 3% and less than about 20%, and α is greater than about 8 degrees and less than about 35 degrees; where AR is equal to or greater than about 2 and less than about 3, Z″ is greater than about 3% and less than about 27%, and α is greater than about 8 degrees and less than about 38 degrees; or where AR is equal to or greater than about 1 and less than about 2, Z″ is greater than about 5% and less than about 45%, and α is greater than about 10 degrees and less than about 48 degrees.

According to a second embodiment of the present invention, a steam turbine includes an axis of rotation and at least one annular steampath defined by an outboard boundary and an inboard boundary between which a plurality of airfoils are arranged tangentially about the axis of rotation and extend radially from the outboard boundary or the inboard boundary; wherein the airfoils each include a concave surface, a convex surface, a leading edge, a trailing edge, a first endwall, and a second endwall; wherein an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further having a plurality of radially stacked cross sections disposed about and at right angles to a stacking axis disposed substantially in the radial direction between the first endwall and the second endwall; each cross section including a portion of the concave surface, convex surface, leading edge, and trailing edge; and further having a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and where AR is equal to or greater than about 3, Z″ is greater than about 3% and less than about 20%, and α is greater than about 8 degrees and less than about 35 degrees; where AR is equal to or greater than about 2 and less than about 3, Z″ is greater than about 3% and less than about 27%, and α is greater than about 8 degrees and less than about 38 degrees; or where AR is equal to or greater than about 1 and less than about 2, Z″ is greater than about 5% and less than about 45%, and α is greater than about 10 degrees and less than about 48 degrees.

According to a third embodiment of the present invention, a steam turbine system includes at least one steam source, at least one expansion section, and at least one condensing section; wherein the at least one expansion section includes an axis of rotation and at least one annular steampath defined by an outboard boundary and an inboard boundary between which a plurality of airfoils are arranged tangentially about the axis of rotation and extend radially from the outboard boundary or the inboard boundary; wherein the airfoils each include a concave surface, a convex surface, a leading edge, a trailing edge, a first endwall, and a second endwall; wherein an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further having a plurality of radially stacked cross sections disposed about and at right angles to a stacking axis disposed substantially in the radial direction between the first endwall and the second endwall; each cross section including a portion of the concave surface, convex surface, leading edge, and trailing edge; and further having a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and where AR is equal to or greater than about 3, Z″ is greater than about 3% and less than about 20%, and α is greater than about 8 degrees and less than about 35 degrees; where AR is equal to or greater than about 2 and less than about 3, Z″ is greater than about 3% and less than about 27%, and α is greater than about 8 degrees and less than about 38 degrees; or where AR is equal to or greater than about 1 and less than about 2, Z″ is greater than about 5% and less than about 45%, and α is greater than about 10 degrees and less than about 48 degrees.

These and other features, aspects and advantages of the present invention may become better understood when the following detailed description is read with reference to the accompanying figures (FIGS), wherein like reference numerals refer to like parts throughout the various views unless otherwise specified.

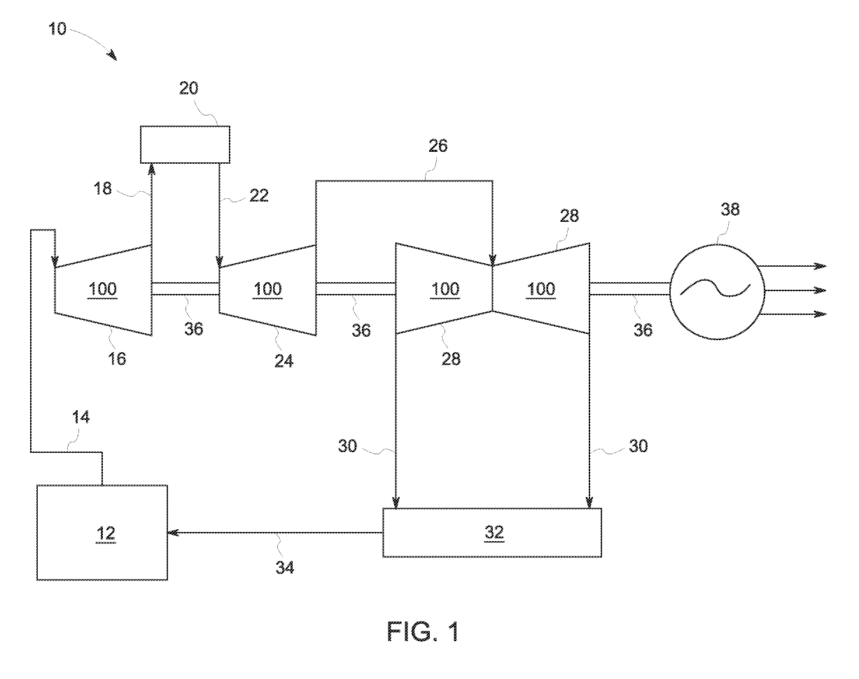

FIG. 1 illustrates a steam turbine electrical power generating system in which embodiments of the present invention may operate.

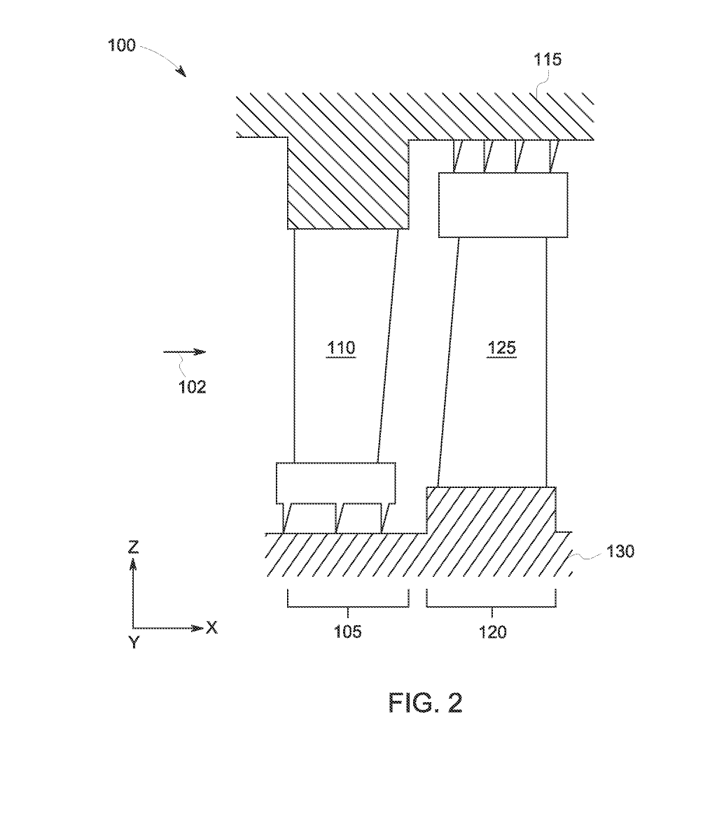

FIG. 2 illustrates an embodiment of the annular steampath of FIG. 1 in which embodiments of the present invention may operate.

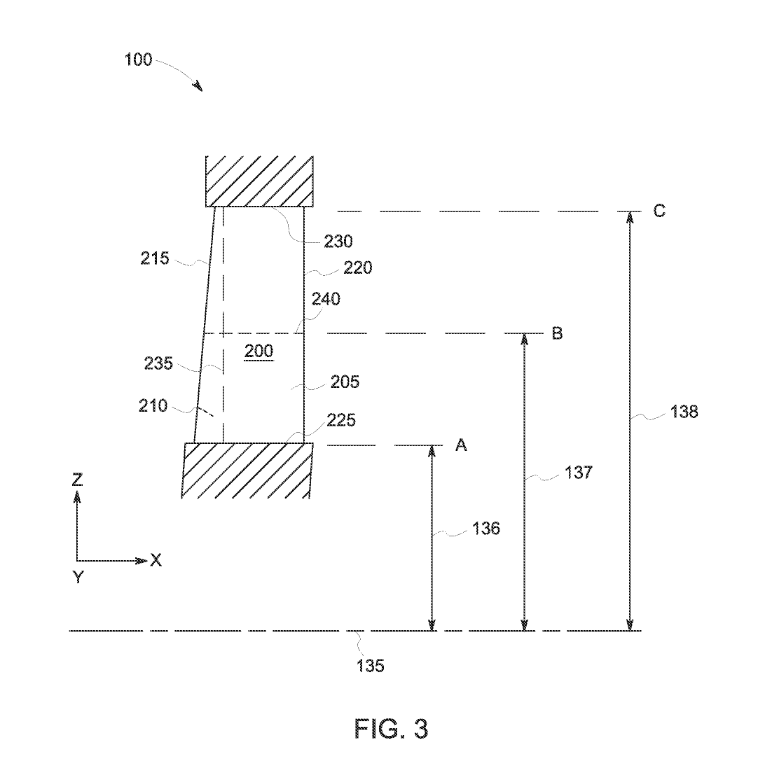

FIG. 3 illustrates an exemplary steam turbine airfoil viewed generally in the axial-radial (X-Z) plane in which embodiments of the present invention may operate.

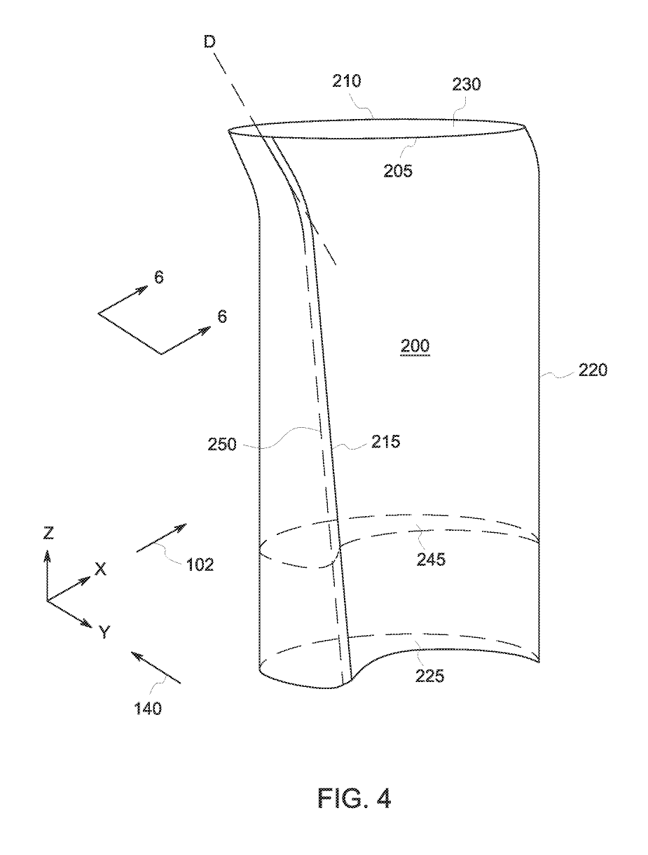

FIG. 4 illustrates an exemplary embodiment of a steam turbine rotating airfoil projected isometrically in accordance with aspects of the present invention.

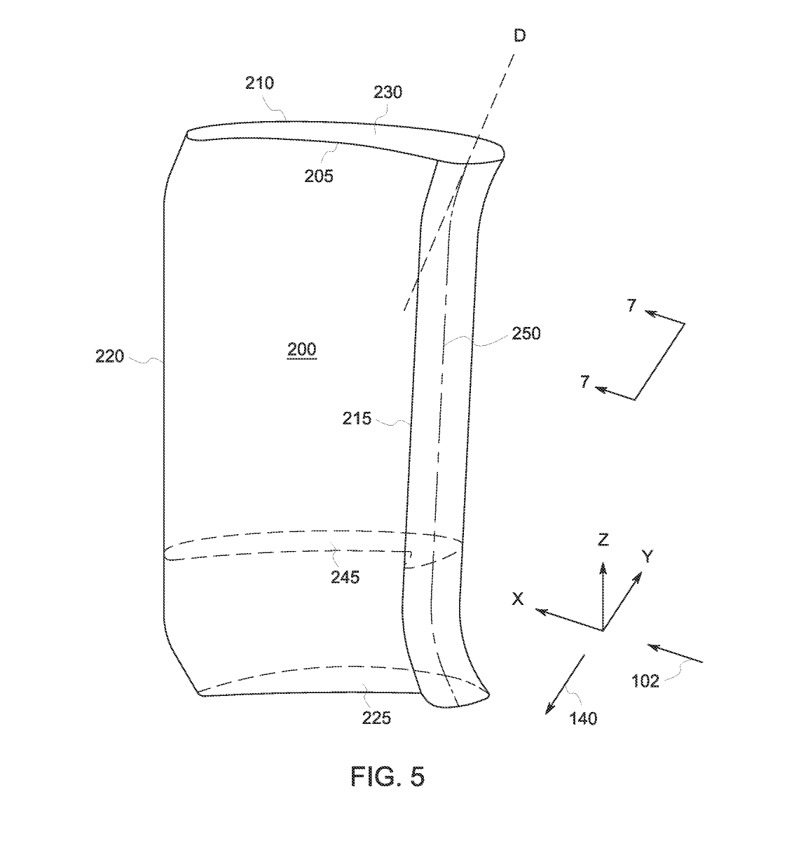

FIG. 5 illustrates an exemplary embodiment of a steam turbine stationary airfoil projected isometrically in accordance with aspects of the present invention.

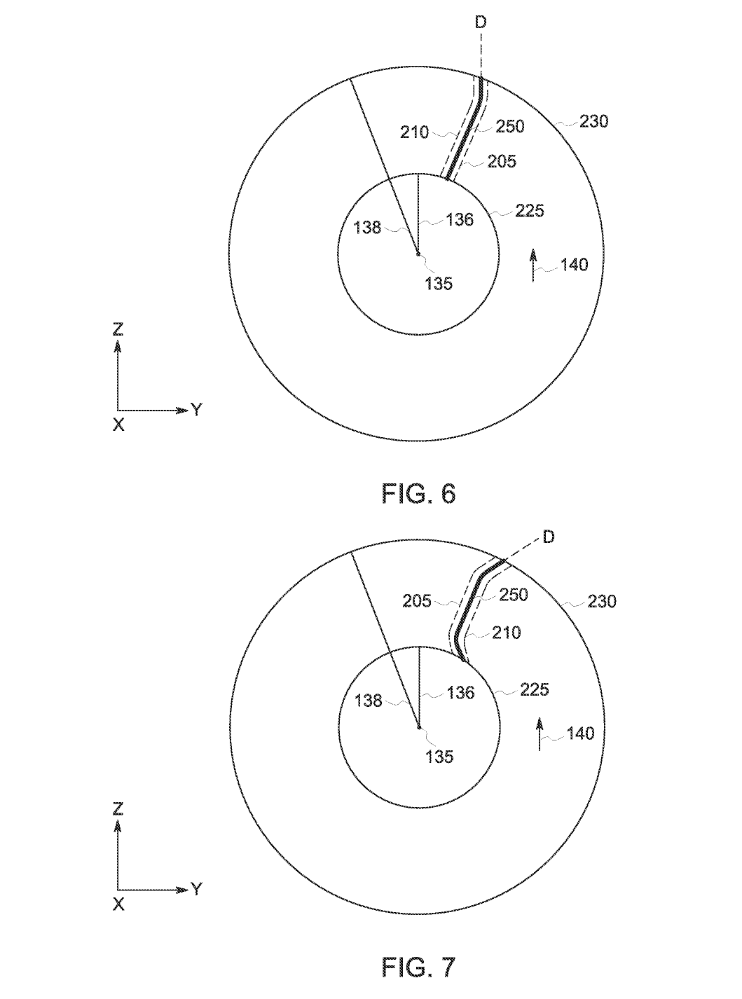

FIG. 6 illustrates aspects of the rotating airfoil stacking axis of FIG. 4 viewed generally along line 6-6 in the tangential-radial (Y-Z) plane.

FIG. 7 illustrates aspects of the stationary airfoil stacking axis of FIG. 5 viewed generally along line 7-7 in the tangential-radial (Y-Z) plane.

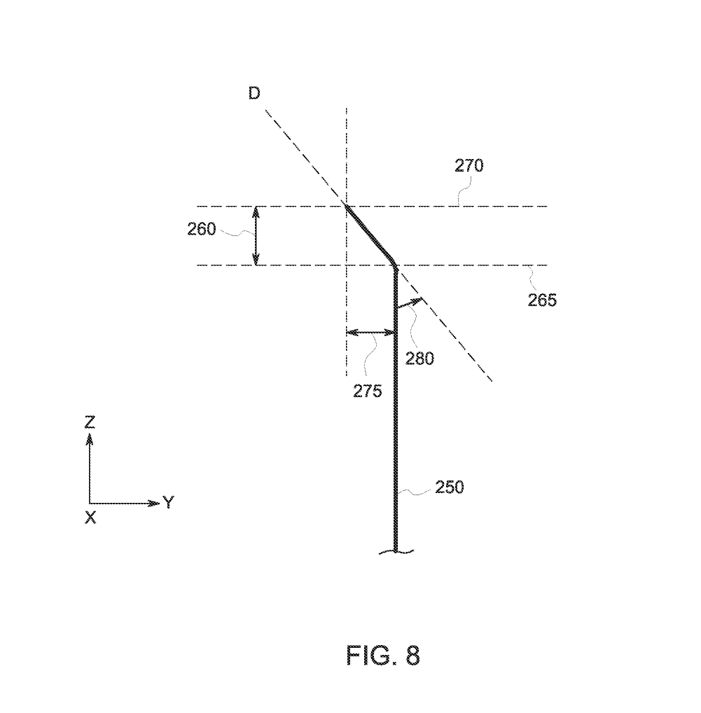

FIG. 8 illustrates a distal portion of the stacking axis of FIGS. 6 and 7 in accordance with aspects of the present invention.

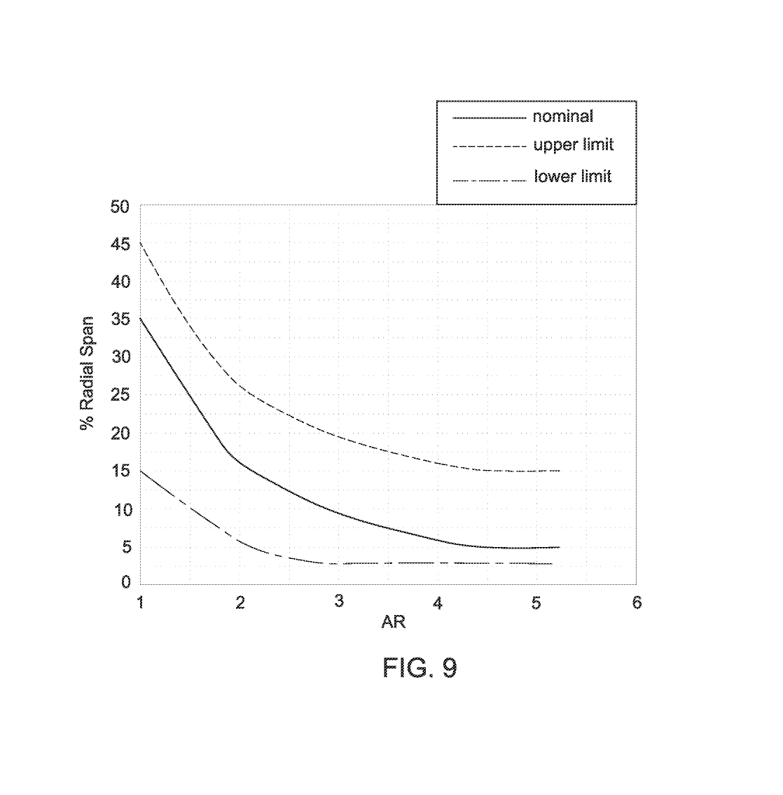

FIG. 9 illustrates a graphical relationship between the airfoil aspect ratio AR and the percentage radial span Z″ in accordance with aspects of the present invention.

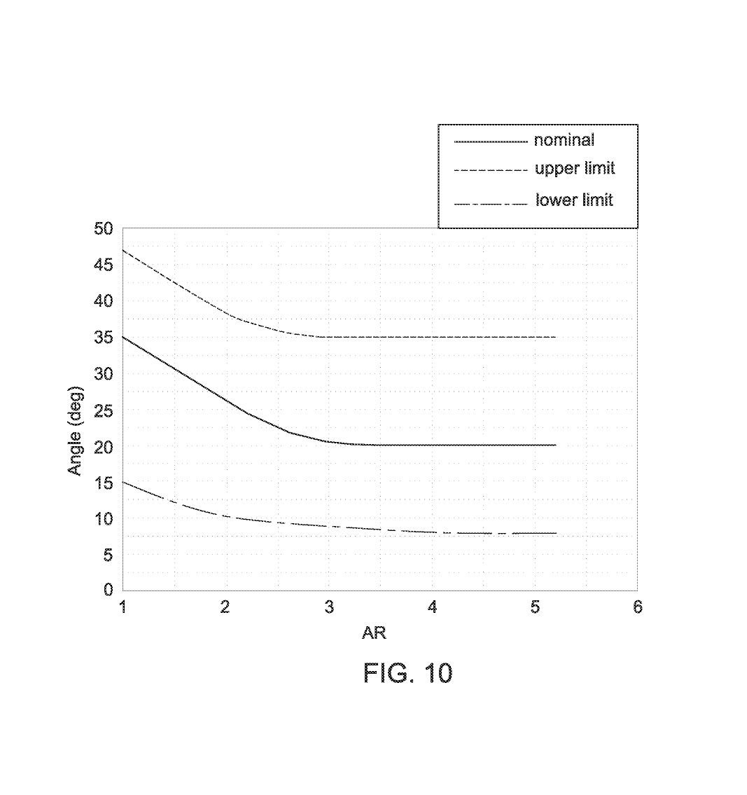

FIG. 10 illustrates a graphical relationship between the airfoil aspect ratio AR and the angle α in accordance with aspects of the present invention.

### DETAILED DESCRIPTION OF THE INVENTION

Specific embodiments of the present invention are described below. This written description, when read with reference to the accompanying figures, provides sufficient detail to enable a person having ordinary skill in the art to practice the invention, including making and using any devices or systems and performing any incorporated methods. However, in an effort to provide a concise description of these embodiments, every feature of an actual implementation may not be described in the specification, and embodiments of the present invention may be employed in combination or embodied in alternate forms and should not be construed as limited to only the embodiments set forth herein. The scope of the invention is, therefore, indicated and limited only by the claims, and may include other embodiments that may occur to those skilled in the art.

The terminology used herein is for describing particular embodiments only and is not intended to be limiting of example embodiments. As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Similarly, the terms “comprises”, “comprising”, “includes” “including”, “has”, and/or “having”, when used herein, specify the presence of stated features, integers, steps, operations, elements, and/or components, but do not preclude the presence or addition of one or more other features, integers, steps, operations, elements, components, and/or groups thereof. As used herein, the term “and/or” includes any, and all, combinations of one or more of the associated listed items.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like, when used without further limitation, merely describe the specific configuration illustrated in the various views. Similarly, the terms “first”, “second”, “primary”, “secondary”, and the like, when used without further limitation, are only used to distinguish one element from another and do not limit the elements described.

Referring now to the figures (FIGS), wherein like reference numerals refer to like parts throughout the various views unless otherwise specified, FIG. 1 illustrates a steam turbine electrical power generating system 10 in which embodiments of the present invention may operate. The steam turbine system 10 includes a boiler 12 or other source that produces dry pressurized steam, which is provided through at least one pipe 14 to a high pressure (HP) turbine expansion section 16, in which energy is extracted from the steam through expansion and cooling within one or more annular steampaths 100. The cooled and partially depressurized steam is provided through at least one pipe 18 to a reheater 20, which raises the temperature of the steam at a constant pressure. The reheated steam is provided through at least one pipe 22 to an intermediate pressure (IP) turbine expansion section 24, which includes one or more annular steampaths 100 in which additional energy is extracted from the steam. The cooled and partially depressurized steam is provided through at least one pipe 26 to one or more low pressure (LP) turbine expansion sections 28 (illustrated as a double opposing flow LP arrangement), which include one or more annular steampaths 100 in which most of the remaining energy is extracted from the steam. The cooled and depressurized steam is provided through at least one pipe 30 to a condensing section 32, which condenses the steam to water that is returned through at least one pipe 34 to the boiler.

The annular steampath 100 includes one or more stages that convert the thermal and kinetic energy extracted from the steam to mechanical torque acting on at least one rotating shaft 36 oriented generally along the axis of rotation (hereinafter referred to as the “axial” direction), wherein each stage includes a plurality of stationary and rotating airfoils arranged tangentially about the axis of rotation. An external load 38, such as an electrical generator, is connected to the shaft 36, thereby converting the mechanical torque to electricity.

FIG. 2 illustrates an embodiment of the annular steampath of FIG. 1 in which embodiments of the present invention may operate. Hot pressurized steam enters the steampath 100 in the generally axial direction indicated by the arrow 102. The steampath 100 includes at least one stationary blade row 105, which includes a plurality of circumferentially adjacent stationary airfoils 110 extending inwardly in a direction generally perpendicular to the axis of rotation (hereinafter referred to as the “radial” direction) from an annular casing 115 or other stationary element that defines an outboard boundary of the steampath. The steampath 100 also includes at least one rotating blade row 120, which includes a plurality of circumferentially adjacent rotating airfoils 125 extending outwardly in the radial direction from a disk or other rotating element 130 that is connected to the rotating shaft 36 (FIG. 1) and that defines an inboard boundary of the steampath.

The stationary blade row 105 together with the rotating blade row 120 form a stage, wherein the airfoils (110, 125) are arranged in the circumferential direction (hereinafter referred to as the “tangential” direction) and disposed in the generally radial direction between the annular casing 115 and the rotating element 130, and where successive stages may be arranged in the axial direction to achieve the desired change in steam pressure, velocity and temperature within the steampath. As further illustrated in FIG. 2, the orientation of the steampath 100 and the associated elements thereof may therefore be described by three orthogonal axes including axial X, tangential Y, and radial Z; where the view illustrated is projected in the axial-radial (X-Z) plane.

FIG. 3 illustrates an exemplary steam turbine airfoil 200 viewed generally in the axial-radial (X-Z) plane in which embodiments of the present invention may operate. The airfoil 200 may be either stationary or rotating; and includes a concave surface 205, a convex surface 210, a leading edge 215, a trailing edge 220, a first endwall 225, and a second endwall 230; wherein the distance between the first endwall and the second endwall substantially in the radial direction Z, as measured from the points where the trailing edge intersects with the first and second endwalls, defines an active length 235, the distance between the leading edge and the trailing edge substantially in the axial direction X at a radial distance of about 50% of the active length defines an axial width 240, and the active length divided by the axial width defines an aspect ratio AR. The airfoil 200 may be formed from a known steel alloy or other suitable material and by any known method; such as machining, casting, forging, pressing, and the like, providing the required properties and dimensions for operation in a steam turbine.

FIG. 3 further illustrates the spatial relationship between the axis of rotation 135 and the airfoil features. Inner radius (R-ID) 136 is defined as the distance in the radial direction Z between the axis of rotation 135 and a cylinder extending in the axial direction X from the first endwall 225, as illustrated by the line A; pitch radius (R-Pitch) 137 is defined as the distance in the radial direction Z between the axis of rotation 135 and a cylinder extending in the axial direction X from the axial width 240, as illustrated by the line B; and outer radius (R-OD) 138 is defined as the distance in the radial direction Z between the axis of rotation 135 and a cylinder extending in the axial direction X from the second endwall 230, as illustrated by the line C. The active length 235 may therefore be alternatively defined as R-OD minus R-ID, and a radius ratio RR may be defined as R-OD divided by R-ID.

FIG. 4 illustrates an exemplary embodiment of a steam turbine rotating airfoil projected isometrically in accordance with aspects of the present invention. The direction of steam flow is indicated by the arrow 102 and direction of rotation is indicated by the arrow 140. The airfoil 200 includes a plurality of radially stacked cross sections 245 that are disposed in the axial-tangential (X-Y) plane about and at right angles to a stacking axis 250, which is disposed substantially in the radial direction Z between the first endwall 225 and the second endwall 230; each cross section including a portion of the concave surface 205, convex surface 210, leading edge 215, and trailing edge 220. The stacking axis includes at least one portion thereof that is offset in the tangential direction Y in the proximity of the second endwall, as illustrated by the line D. While the stacking axis is illustrated as two substantially straight lines joined by a simple curve, it should be understood that the stacking axis may be entirely curved or may include additional lines having simple or compound curvatures while still falling within the meaning and scope of the claims.

FIG. 5 illustrates an exemplary embodiment of a steam turbine stationary airfoil projected isometrically in accordance with aspects of the present invention. The direction of steam flow is indicated by the arrow 102 and direction of rotation is indicated by the arrow 140. The airfoil 200 includes a plurality of radially stacked cross sections 245 that are disposed in the axial-tangential (X-Y) plane about a stacking axis 250, which is disposed substantially in the radial direction Z between the first endwall 225 and the second endwall 230; each cross section including a portion of the concave surface 205, convex surface 210, leading edge 215, and trailing edge 220. The stacking axis 250 includes at least one portion thereof that is offset in the tangential direction Y in the proximity of the first endwall, the second endwall, or both endwalls as illustrated by the line D. While the stacking axis is illustrated as three substantially straight lines joined by simple curves, it should be understood that the stacking axis may be entirely curved or may include additional lines having simple or compound curvatures while still falling within the meaning and scope of the claims.

FIG. 6 illustrates aspects of the rotating airfoil stacking axis of FIG. 4 viewed generally along line 6-6 in the tangential-radial (Y-Z) plane. The first endwall 225 and second endwall 230 extend circumferentially from the stacking axis 250 in the tangential direction Y, thereby forming annuli located at the radial distances 136 and 138, respectively, from the axis of rotation 135, wherein the direction of rotation is indicated by the arrow 140. The direction of the tangential offset (also known as tangential lean) illustrated by the line D, is toward the convex surface 210 and away from the concave surface 205.

FIG. 7 illustrates aspects of the stationary airfoil stacking axis of FIG. 5 viewed generally along line 7-7 in the tangential-radial (Y-Z) plane. The first endwall 225 and second endwall 230 extend circumferentially from the stacking axis 250 in the tangential direction Y, thereby forming annuli located at the radial distances 136 and 138, respectively, from the axis of rotation 135, wherein the direction of rotation is indicated by the arrow 140. The direction of the tangential offset (also known as tangential lean) illustrated by the line D, is toward the convex surface 210 and away from the concave surface 205.

FIG. 8 illustrates a distal portion of the stacking axis of FIGS. 6 and 7 in accordance with aspects of the present invention. The stacking axis 250 includes a radial offset (Z′) 260, defined as a distance substantially in the radial direction Z between a first cross section 265 and a second cross section 270, wherein the second cross section may be located at substantially the same radial span and coplanar in the axial-tangential (X-Y) plane with the second endwall 230 (FIG. 6) for rotating airfoil embodiments, or with either the first endwall 225 or the second endwall 230 (FIG. 7) for stationary airfoil embodiments. The radial offset 260 may also be described by the percentage radial span (Z″), defined as a distance substantially in the radial direction Z, as a percentage of the active length, between the first and second cross sections. The airfoil 200 also includes a tangential offset (Y′) 275, which is defined as a distance disposed substantially in a tangential direction between a point of intersection between the stacking axis and the first cross section and a point of intersection between the stacking axis and the second cross section. The airfoil 200 also includes an angle (α) 280, wherein the tangent of α is equal to Y′ divided by Z′.

FIG. 9 illustrates a graphical relationship between the airfoil aspect ratio AR and the percentage radial span Z″ in accordance with aspects of the present invention. Similarly, FIG. 10 illustrates a graphical relationship between the airfoil aspect ratio AR and the angle α in accordance with aspects of the present invention. FIGS. 9 and 10 include the nominal relationship and the upper and lower tolerance limits on Z″ and α, respectively, which have been shown by analysis to provide the greatest aerodynamic benefit for steam turbine airfoils.

According to an embodiment of the present invention, an exemplary airfoil includes an active length of about 11 cm, an axial width of about 2.2 cm, an inner radius R-ID of about 37 cm, and an outer radius R-OD of about 48 cm; yielding an aspect ratio AR of about 5.0 and a radius ratio RR of about 1.3. The airfoil also includes a radial offset Z′ of about 0.6 cm and a tangential offset Y′ of about 0.2 cm, yielding a percentage radial span Z″ of about 5% and an angle α of about 19 degrees.

According to another embodiment of the present invention, an exemplary airfoil includes an active length of about 8.8 cm, an axial width of about 2.0 cm, an inner radius R-ID of about 37 cm, and an outer radius R-OD of about 46 cm; yielding an aspect ratio AR of about 4.3 and a radius ratio RR of about 1.2. The airfoil also includes a radial offset Z′ of about 0.5 cm and a tangential offset Y′ of about 0.2 cm, yielding a percentage radial span Z″ of about 6% and an angle α of about 19 degrees.

According to another embodiment of the present invention, an exemplary airfoil includes an active length of about 6.1 cm, an axial width of about 2.0 cm, an inner radius R-ID of about 37 cm, and an outer radius R-OD of about 43 cm; yielding an aspect ratio AR of about 3.0 and a radius ratio RR of about 1.2. The airfoil also includes a radial offset Z′ of about 0.6 cm and a tangential offset Y′ of about 0.2 cm, yielding a percentage radial span Z″ of about 10% and an angle α of about 19 degrees.

According to another embodiment of the present invention, an exemplary airfoil includes an active length of about 3.2 cm, an axial width of about 1.9 cm, an inner radius R-ID of about 33 cm, and an outer radius R-OD of about 36 cm; yielding an aspect ratio AR of about 1.7 and a radius ratio RR of about 1.1. The airfoil also includes a radial offset Z′ of about 0.7 cm and a tangential offset Y′ of about 0.4 cm, yielding a percentage radial span Z″ of about 21% and an angle α of about 28 degrees.

As described above, the present invention contemplates an aerodynamically efficient turbine airfoil that includes a first endwall, a second endwall, a stacking axis, an aspect ratio, a percentage radial span, a tangential offset, and an angle; wherein relationships between the aspect ratio, percentage radial span, and angle are defined. As defined herein, the term “endwall” may refer to any element, such as a platform, shroud, or other means providing structural support for the airfoil and having surfaces oriented in a direction generally parallel to the axis of rotation. It is also noted that the embodiments so described and illustrated herein are typical of heavy duty axial-flow reheat steam turbine electrical power generating systems, but it should be understood that other suitable arrangements and uses may be substituted for the embodiments shown while still falling within the meaning and scope of the claims.

Although specific embodiments are illustrated and described herein, including the best mode, those of ordinary skill in the art will appreciate that all additions, deletions and modifications to the embodiments as disclosed herein and which fall within the meaning and scope of the claims may be substituted for the specific embodiments shown. Similarly, other embodiments of the invention may be devised which do not depart from the spirit or scope of the present invention. Such other embodiments are intended to be within the scope of the claims if they have structural elements that do not differ from the literal language of the claims, or if they include equivalent structural elements with insubstantial differences from the literal languages of the claims. Likewise, the system components illustrated are not limited to the specific embodiments described herein, but rather, system components can be utilized independently and separately from other components described herein. For example, the components and assemblies described herein may be employed in any suitable type of steam turbine, gas turbine or other turbomachine while still falling within the meaning and scope of the claims.

What is claimed is:

1. A turbine airfoil comprising:
a concave surface, a convex surface, a leading edge, a trailing edge, a first endwall, and a second endwall; wherein:
an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further comprising:
a plurality of radially stacked cross sections disposed about and at right angles to a stacking axis disposed substantially in the radial direction between the first endwall and the second endwall; each cross section comprising a portion of the concave surface, convex surface, leading edge, and trailing edge; and further comprising:
a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and:
where AR is equal to or greater than about 3, Z″ is greater than about 3% and less than about 20%, and α is greater than about 8 degrees and less than about 35 degrees;
where AR is equal to or greater than about 2 and less than about 3, Z″ is greater than about 3% and less than about 27%, and α is greater than about 8 degrees and less than about 38 degrees; or
where AR is equal to or greater than about 1 and less than about 2, Z″ is greater than about 5% and less than about 45%, and α is greater than about 10 degrees and less than about 48 degrees.

2. The airfoil of claim 1:
where AR is about 5.0, Z″ is about 5%, and α is about 19 degrees;
where AR is about 4.3, Z″ is about 6%, and α is about 19 degrees;
where AR is about 3.0, Z″ is about 10%, and α is about 19 degrees; or
where AR is about 1.7, Z″ is about 21%, and α is about 28 degrees.

3. The airfoil of claim 1, wherein the airfoil is configured as a rotating airfoil and the direction of the tangential offset Y′ is toward the convex surface and away from the concave surface.

4. The airfoil of claim 1, wherein the airfoil configured as a rotating airfoil and the second cross section is located at substantially the same radial span and coplanar with the second endwall.

5. The airfoil of claim 1, wherein the airfoil configured as a stationary airfoil and the direction of the tangential offset Y′ is toward the convex surface and away from the concave surface.

6. A steam turbine comprising an axis of rotation and at least one annular steampath defined by an outboard boundary and an inboard boundary between which a plurality of airfoils are arranged tangentially about the axis of rotation and extend radially from the outboard boundary or the inboard boundary; wherein the airfoils each comprise:
a concave surface, a convex surface, a leading edge, a trailing edge, a first endwall, and a second endwall; wherein:
an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further comprising:
a plurality of radially stacked cross sections disposed about and at right angles to a stacking axis disposed substantially in the radial direction between the first endwall and the second endwall; each cross section comprising a portion of the concave surface, convex surface, leading edge, and trailing edge; and further comprising:
a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and:
where AR is equal to or greater than about 3, Z″ is greater than about 3% and less than about 20%, and α is greater than about 8 degrees and less than about 35 degrees;
where AR is equal to or greater than about 2 and less than about 3, Z″ is greater than about 3% and less than about 27%, and α is greater than about 8 degrees and less than about 38 degrees; or
where AR is equal to or greater than about 1 and less than about 2, Z″ is greater than about 5% and less than about 45%, and α is greater than about 10 degrees and less than about 48 degrees.

7. The steam turbine of claim 6:
where AR is about 5.0, Z″ is about 5%, and α is about 19 degrees;
where AR is about 4.3, Z″ is about 6%, and α is about 19 degrees;
where AR is about 3.0, Z″ is about 10%, and α is about 19 degrees; or
where AR is about 1.7, Z″ is about 21%, and α is about 28 degrees.

8. The steam turbine of claim 6, wherein the airfoils each comprise a rotating airfoil and the direction of the tangential offset Y′ is toward the convex surface and away from the concave surface.

9. The steam turbine of claim 6, wherein the airfoils each comprise a rotating airfoil and the second cross section is located at substantially the same radial span and coplanar with the second endwall.

10. The steam turbine of claim 6, wherein the airfoils each comprise a stationary airfoil and the direction of the tangential offset Y′ is toward the convex surface and away from the concave surface.

11. A steam turbine system comprising at least one steam source, at least one expansion section, and at least one condensing section; wherein the at least one expansion section comprises an axis of rotation and at least one annular steampath defined by an outboard boundary and an inboard boundary between which a plurality of airfoils are arranged tangentially about the axis of rotation and extend radially from the outboard boundary or the inboard boundary; wherein the airfoils each comprise:
a concave surface, a convex surface, a leading edge, a trailing edge, a first endwall, and a second endwall; wherein:
an active length is defined by a distance between the first endwall and the second endwall substantially in a radial direction, an axial width is defined by a distance between the leading edge and the trailing edge substantially in an axial direction at a radial distance of about 50% of the active length, and the active length divided by the axial width defines an aspect ratio AR; and further comprising:
a plurality of radially stacked cross sections disposed about and at right angles to a stacking axis disposed substantially in the radial direction between the first endwall and the second endwall; each cross section comprising a portion of the concave surface, convex surface, leading edge, and trailing edge; and further comprising:
a first distance Z″ defined as a percentage of the active length disposed between a first cross section and a second cross section, wherein the second cross section is located at substantially the same radial span and coplanar with the first endwall or the second endwall; a second distance Y′ defined as a distance disposed substantially in a tangential direction between a point of intersection between the stacking axis and the first cross section and a point of intersection between the stacking axis and the second cross section; and an angle α, wherein the tangent of α is equal to the second distance Y′ divided by the first distance Z′; and:
where AR is equal to or greater than about 3, Z″ is greater than about 3% and less than about 20%, and α is greater than about 8 degrees and less than about 35 degrees;
where AR is equal to or greater than about 2 and less than about 3, Z″ is greater than about 3% and less than about 27%, and α is greater than about 8 degrees and less than about 38 degrees; or
where AR is equal to or greater than about 1 and less than about 2, Z″ is greater than about 5% and less than about 45%, and α is greater than about 10 degrees and less than about 48 degrees.

12. The steam turbine system of claim 11:
where AR is about 5.0, Z″ is about 5%, and α is about 19 degrees;
where AR is about 4.3, Z″ is about 6%, and α is about 19 degrees;
where AR is about 3.0, Z″ is about 10%, and α is about 19 degrees; or
where AR is about 1.7, Z″ is about 21%, and α is about 28 degrees.

13. The steam turbine system of claim 11, wherein the airfoils each comprise a rotating airfoil and the direction of the tangential offset Y′ is toward the convex surface and away from the concave surface.

14. The steam turbine system of claim 11, wherein the airfoils each comprise a rotating airfoil and the second cross section is located at substantially the same radial span and coplanar with the second endwall.

15. The steam turbine system of claim 11, wherein the airfoils each comprise a stationary airfoil and the direction of the tangential offset Y′ is toward the convex surface and away from the concave surface.
